(19) United States
(12) Patent Application Publication
(10) Pub. No.: US 2017/0315283 A1
(43) Pub. Date: Nov. 2, 2017

(54) DISPLAY DEVICE

(71) Applicant: SAMSUNG DISPLAY CO., LTD., Yongin-Si (KR)

(72) Inventors: Hyunwoo LEE, Anyang-si (KR); Eunju NAM, Seoul (KR); Hyun-hwa SONG, Hwaseong-si (KR)

(21) Appl. No.: 15/426,692

(22) Filed: Feb. 7, 2017

(30) Foreign Application Priority Data
May 2, 2016 (KR) 10-2016-0054173

(51) Int. Cl. F21V 8/00

(52) U.S. Cl. CPC G02B 6/0003; G02B 6/0038

(57) ABSTRACT

A display device includes a light source unit which provides light, a light guide plate which includes a plurality of faces, a plurality of optical patterns configured to convert a wavelength of incident light received from the light source unit, and disposed on at least one face of the plurality of faces, and a display panel which is disposed on the light guide plate and configured to display an image by receiving light emitted from the light guide plate, wherein each optical pattern of the plurality of optical patterns includes an optical resin including an organic phosphor which converts the wavelength of the incident light, and a base material.

This U.S. application claims priority to Korean Patent Application No. 10-2016-0054173, filed on May 2, 2016, and all the benefits accruing therefrom under 35 U.S.C. §119, the entire content of which in its entirety is herein incorporated by reference.

### BACKGROUND

### 1. Field of Disclosure

The present disclosure relates to a display device, and in particular, to a display device capable of converting the wavelength of light emitted from a light source and providing the converted wavelength of light to a display panel.

### 2. Description of the Related Art

Display devices may be classified into liquid crystal display devices, plasma display devices, organic electroluminescent display devices, field effect display devices, electrophoretic display devices, and the like. Among such display devices, a liquid crystal display device includes both light receiving and light emitting elements, which are incapable of self-emission and thus utilize a separate light source. In particular, with regard to such liquid display devices, techniques are being developed for the manufacture of display devices which are capable of displaying an image by efficiently utilizing the light emitted from the separate light source. Recently, there has been an increased interest in techniques which utilize excited, light emitting bodies such as various types of phosphors, to enhance the color and color reproducibility of liquid crystal display devices.

### SUMMARY

An object of the present disclosure is to provide a display device having enhanced color and color reproducibility.

An embodiment provides a display device including a light source unit which provides light; a light guide plate which includes a plurality of faces, a plurality of optical patterns configured to convert incident light received from the light source unit, an disposed on at least one face of the plurality of faces; and a display panel which is disposed on the light guide plate and configured to display an image by receiving light emitted from the light guide plate, wherein each optical pattern of the plurality of optical patterns includes an optical resin comprising an organic phosphor which converts a wavelength of the incident light, and a base material.

In an embodiment, the plurality of faces may include a light incident face, which faces the light source unit and a light emitting face, which is perpendicular to the light incident face and parallel to the display panel; and the plurality of optical patterns may further include a plurality of recessed portions defined in the light emitting face.

In an embodiment, the plurality of recessed portions may be v-shaped and have a predetermined depth; and the optical resin may be disposed so as fill each recessed portion of the plurality of recessed portions.

In an embodiment, the plurality of faces may include a light emitting face, which is configured to emit the converted incident light and a reflecting face, which is parallel to the light emitting face; and the plurality of optical patterns may further include a plurality of protruding portions which protrude from the reflecting face.

In an embodiment, the plurality of protruding portions may be include the optical resin, and are disposed such that the cross-sections thereof have a shape selected from at least one of a circular shape, an elliptical shape, and a polygonal shape.

In an embodiment, the plurality of faces may include a light incident face, which faces the light source unit; and with respect to the plurality of optical patterns, at least one selected from a spacing between the optical patterns, a size of each of the optical patterns, and a number of the optical patterns may changes as a distance from the light incident face is increased.

In an embodiment, the spacing between the optical patterns may decrease as the distance from the light source unit increases.

In an embodiment, the light guide plate may include a first area positioned a first distance from the light source unit; and a second area positioned a second distance from the light source unit, wherein the second distance is greater than the first distance, and wherein a first optical resin included in the optical patterns disposed in the first area includes an amount of the organic phosphor which is less than an amount of the organic phosphor in a second optical resin included in the optical patterns disposed in the second area.

In an embodiment, further included is an optical sheet between the light guide plate and the display panel, wherein; the plurality of faces may include a light emitting face, which faces the display panel and is configured to emit the converted incident light; and the plurality of optical patterns may be disposed on the light emitting face.

In an embodiment, the light emitting face and the optical sheet may be in direct contact with each other.

In an embodiment, the light source unit may provide a first light to the light guide plate; and the organic phosphors may include a first organic phosphor which is configured to absorb the first light and emit a second light and a second organic phosphor, which is configured to absorb the first light and emit a third light, wherein the first light may have a peak wavelength in the wavelength range of about 400 to about 500 nanometers (nm), the second light may have a peak value in the wavelength range of about 500 to about 600 nm, and the third light may have a peak value in the wavelength range of about 600 to about 700 nm.

In an embodiment, the organic phosphors may include at least one compound selected from Compound Group 1.

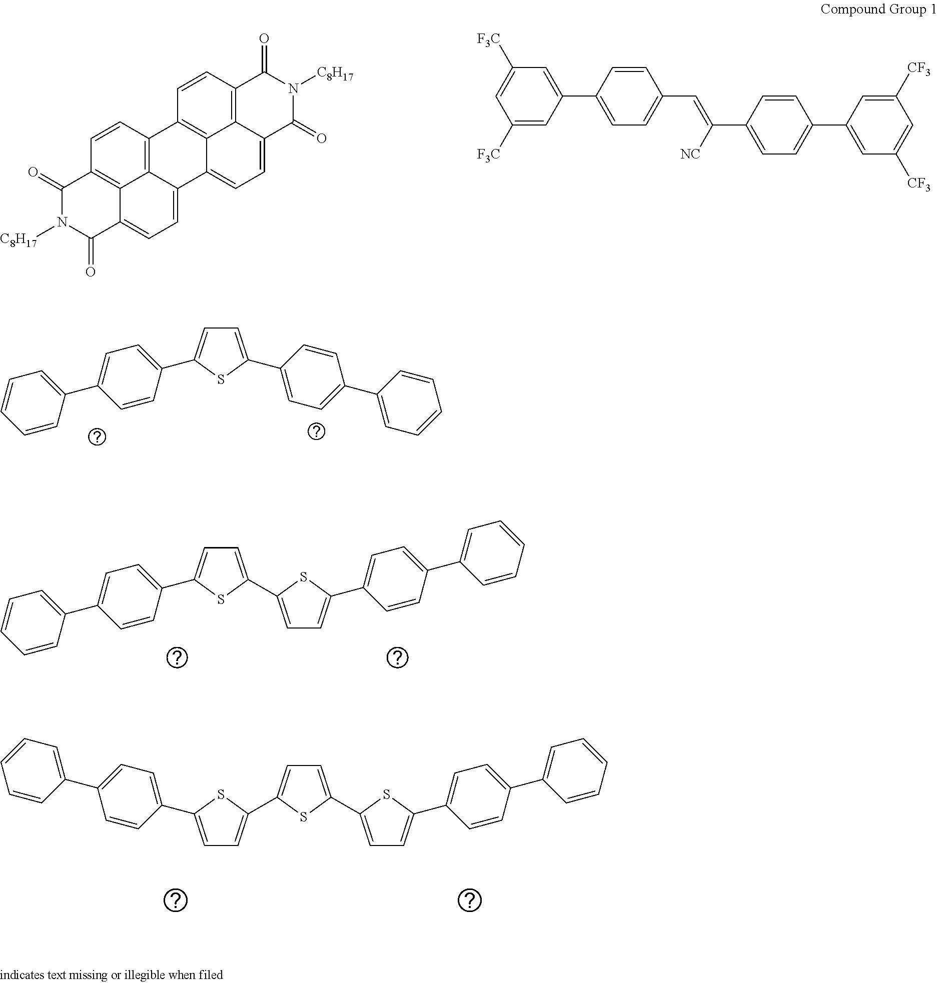

In an embodiment, the organic phosphors may include at least one selected from poly(9,9-dioctyl)fluorine, poly(9,9-di(ethylhexyl)fluorine), poly(9,9-dioctylfluorene-co-benzothiadiazole), and poly(9,9-dioctylfluorene-co-dithiophene).

In an embodiment, a display device includes an optical unit and a display panel disposed on the optical unit and configured to display an image, wherein the optical unit includes: a light source unit which provides light; a light guide plate which is configured to direct light received from the light source unit toward the display panel; and an optical member disposed on a face of the light guide plate and including a plurality of optical patterns configured to convert the light received from the light source unit, wherein the optical member includes an organic phosphor which converts a wavelength of the light received from the light source unit.

In an embodiment, the optical member may include, on the face the light guide plate: a first optical area positioned a first distance from the light source unit; and a second optical area positioned a second distance from the light source unit, wherein the second distance is greater than the first distance, and the second optical area includes the organic phosphor in an amount which is greater than the amount of the organic phosphor in the first optical area.

In an embodiment, the optical unit further may include an optical sheet between the light guide plate and the display panel, and a face of the light guide plate may be a light emitting face which is configured to emit the converted light received from the light source.

In an embodiment, the optical sheet may be in direct contact with the optical member.

In an embodiment, a display device includes a light source unit which provides light; a light guide plate including a light incident face which faces the light source unit, a light emitting face which is perpendicular to the light incident face and configured to emit light received from the light source unit, and a reflecting face which is perpendicular to the light incident face and parallel to the light emitting face; and a display panel which is disposed on the light guide plate and configured to display an image by receiving light emitted from the light emitting face, wherein a plurality of first optical patterns are provided on the light emitting face and a plurality of second optical patterns are provided on the reflecting face, and wherein at least one of the plurality of first optical patterns or the plurality of second optical patterns includes an optical resin comprising an organic phosphor which is configured to convert a wavelength of the light received from the light source unit, and a base material.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is an exploded perspective view schematically illustrating a display device, according to an embodiment;

FIGS. 2A and 2B illustrate a light guide plate in which a plurality of optical patterns are formed, according to an embodiment;

FIG. 3A illustrates a light guide plate in which an optical resin is included in the plurality of optical patterns illustrated in FIG. 2A;

FIG. 3B illustrates an embodiment in which the plurality of optical patterns illustrated in FIG. 3A are formed of an optical resin;

FIGS. 4A and 4B are cross-sectional views of a light guide plate, according to another embodiment;

FIG. 5A is a cross-sectional view illustrating the path of light in a light guide plate, according to an embodiment;

FIG. 5B is a comparative cross-sectional view illustrating the path of light when a barrier film is disposed on a light guide plate;

FIG. 6 is a cross-sectional view of a light guide plate showing the change in concentration of an optical resin according to the distance from a light source unit;

FIG. 7 illustrates a portion of a light guide plate and shows a change in distance between the optical patterns according to the distance from a light source unit;

FIG. 8 is an exploded perspective view schematically illustrating a display device, according to another embodiment;

FIG. 9 is a cross-sectional view illustrating a portion of a light guide plate, according to another embodiment; and

FIG. 10 is a cross-sectional view illustrating a portion of a light guide plate, according to another embodiment.

### DETAILED DESCRIPTION

As the present concept may be changed in various ways and be embodied in various forms, exemplary embodiments of the will be described below in detail with reference to the accompanying drawings. However, the should not be construed as limited to the embodiments set forth herein, but rather, should be construed as including all modifications, equivalents, and substitutes within the conceptual and technical scope of the invention.

In describing the respective figures, like reference numerals were used to refer to like elements. Although terms such as “first”, “second”, etc. may be used in describing various elements, components, regions, layers and/or sections, these elements, components, regions, layers and/or sections should not be limited by these terms. The terms are only used to distinguish one element, component, region, layer and/or section from another element, component, region, layers, and/or section. For example, “a first element,” “component,” “region,” or “section” could be termed a second element component, region, or section, and likewise, a second element, component, region, or section could be termed a first element, component, region, or section without departing from the scope of the teachings herein. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items.

It will be further understood that the terms “comprises” and/or “comprising,” or “includes,” “including,” and/or “has” or “having,” when used in this specification, specify the presence of stated features, integers, steps, operations, elements, components, or combinations thereof, but do not preclude the presence or addition of one or more other features, integers, steps, operations, elements, components, or combinations thereof. Moreover, it will be understood that when an element or layer is referred to as being “on” another element or layer, it can be “directly on” the other element or layer or intervening elements or layers may be present. When an element or layer is referred to as being “below” another element or layer, it can be “directly below” the other element or layer or intervening elements or layers may be present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments will be described in greater detail with reference to the drawings.

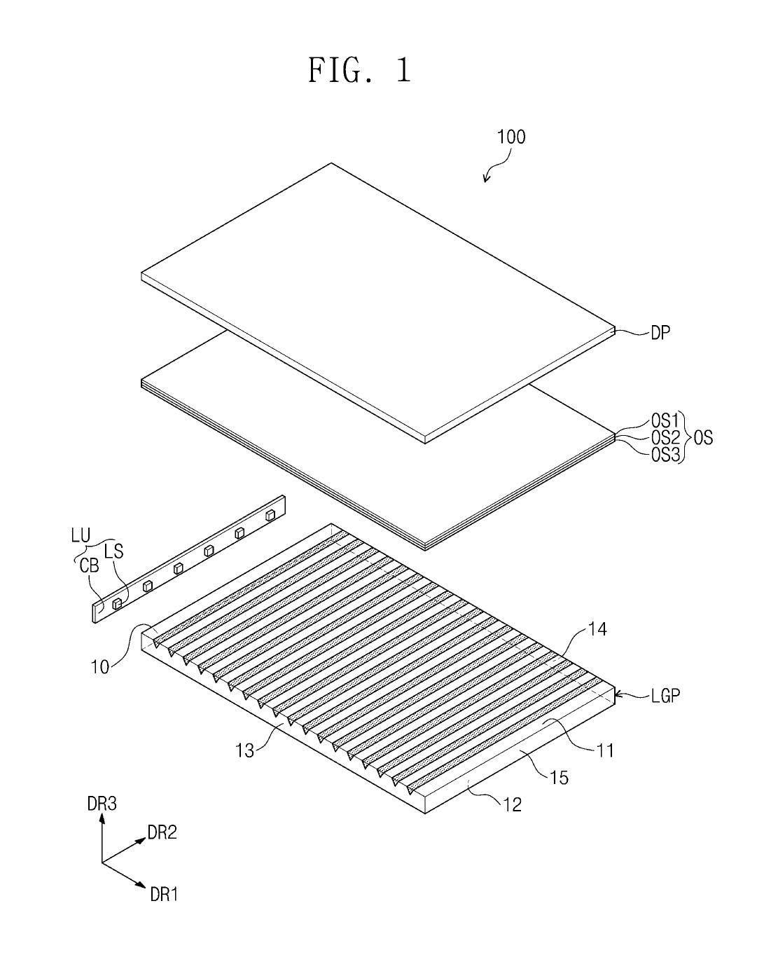

FIG. 1 is an exploded perspective view schematically illustrating a display device according to an embodiment.

Referring to FIG. 1, a display device 100 according to an embodiment of the may include a light source unit LU, a light guide plate LGP, and a display panel DP.

The light source unit LU may provide light to the light guide plate LGP. In FIG. 1, the light source unit LU is exemplarily illustrated as being disposed on only one of the sides of the light guide plate LGP. However, the light source unit LU is not limited thereto, and multiple light source units LU may be disposed along the other sides of the light guide plate LGP.

The light source unit LU may include a light source LS and a circuit board CB which applies electrical power to the light source LS. For example, a light emitting diode (LED), a cold cathode fluorescence lamp (CCFL), an external electrode fluorescent lamp (EEEF), or a hot cathode fluorescent lamp (HCFL), and the like, may be used as the light source LS. There may be one light source LS or multiple light sources LS, which may be arranged so as to be spaced apart from each other in a second direction DR2 on the circuit board CB. The light source LS may provide a first light to the light guide plate LGP. The first light may be a blue light having a peak wavelength value in the wavelength range of about 400 nanometers (nm) to about 500 nm.

The light guide plate LGP may direct incident light received from the light source unit LU toward the display panel DP. The light guide plate LGP may have a long side oriented in the first direction DR1 and a short side oriented in a second direction DR2 intersecting the first direction DR1. The light guide plate LGP may include a light emitting face 11, a reflecting face 12, and a plurality of connecting faces 10, 13, 14, and 15, which connect the light emitting face 11 with the reflecting face 12.

The light emitting face 11 may emit the first light which has been incident through a light incident face 10 toward the display panel DP. The light emitting face 11 may be perpendicular to the light incident face 10 and may be disposed so as to be spaced apart from the display panel DP in a third direction DR3. The reflecting face 12 may be positioned further away from the display panel DP in the third direction DR3 than the light emitting face 11. Moreover, the reflecting face 12 may reflect the first light that has passed through the light incident face 10 toward the display panel DP.

The plurality of connecting faces 10, 13, 14, and 15 may be side faces that connect the light emitting face 11 with the reflecting face 12. More specifically, the plurality of connecting faces 10, 13, 14, and 15 may include the light incident face 10, which faces the light source unit LU and receives the first light provided from the light source unit LU. In addition, the plurality of connecting faces 10, 13, 14, and 15 may include a first side face 13 and a second side face 14, which are parallel to each other, and a third side face 15, which is disposed parallel to the reflecting face 10.

The type of light guide plate LGP may be used without particular limit, and may include polymer resins or glass. The polymer resin may be a transparent polymer resin, for example, at least one selected from polycarbonate, polymethyl methacrylate, polydimethylsiloxane, polystyrene, and methacrylate styrene copolymer.

A plurality of optical patterns for converting the first light received from the light source unit LU and emitting the light to the display panel DP may be formed on at least one face of the light guide plate LGP. Moreover, an optical resin which can convert the first light, may be included in each of the plurality of optical patterns. Related embodiments are described below.

The display panel DP may be disposed above the light guide plate LGP. More specifically, the display panel DP may be disposed above the light emitting face 11 of the light guide plate LGP. The display panel DP may receive the light emitted from the light emitting face 11 and display an image. The display panel DP may be a variety of light receiving and emitting type display panels, such as a liquid crystal display panel, a plasma display panel, an electrophoretic display panel, a MEMS display panel, an electrowetting display panel, etc. Herein, embodiments are described in which the display panel DP is a liquid crystal display panel.

The liquid crystal display panel may be a panel which operates in any one of a vertical alignment (VA) mode, a patterned vertical alignment (PVA) mode, an in-plane switching (IPS) mode, a fringe-field switching (FFS) mode, or a plane to line switching (PLS) mode, and is not limited to panels of a particular mode.

Referring to FIG. 1, the display device 100 according to an embodiment of the may include at least one optical sheet OS between the light guide plate LGP and the display panel DP. The optical sheet OS may change the path or intensity of light emitted from the light guide plate LGP and thereby improve the brightness or viewing angle of the light. The optical sheet OS may include a diffusion sheet which diffuses light toward the display panel DP, a prism sheet which focuses light in a direction perpendicular to the plane of the display panel DP, a protective sheet which protects the diffusion sheet and the prism sheet from external impact, and the like. In a more specific example, referring to FIG. 1, the optical sheet OS may include first to third optical sheets OS1, OS2, and OS3, which are stacked in order on the light emitting face 11 of the light guide plate LGP. For example, the first optical sheet OS1 may be a diffusion sheet that diffuses light emitted from the light guide plate LGP. The second optical sheet OS2 may be a prism sheet that focuses the light diffused by the diffusion sheet. The third optical sheet OS3 may be a protective sheet. However, the type or stacking order of the optical sheets OS is not limited, and at least one of the first to third optical sheets OS1, OS2, and OS3 may be used by overlapping multiple sheets thereof, or one or more of the optical sheets may be omitted as needed.

Although not shown in FIG. 1, the display device 100, according to an embodiment may further include a reflective sheet below the light guide plate LGP. The reflective sheet may increase the amount of light provided to the display panel DP by reflecting toward the display panel DP, the light which—among the first light received from the light source unit LU—was leaked and did not travel toward the display panel DP.

Moreover, although not shown in FIG. 1, the display device 100 according to an embodiment may further include a bottom chassis or a mold frame. For example, the bottom chassis may be stored below the light guide plate LGP, the light source unit LU, light guide plate LGP, the optical sheets OS, and the display panel DP. In addition, the mold frame may, for example, be integrated with, or separate from, the bottom chassis, and may be provided along the edges of the display panel DP and support the display panel DP from below the display panel DP.

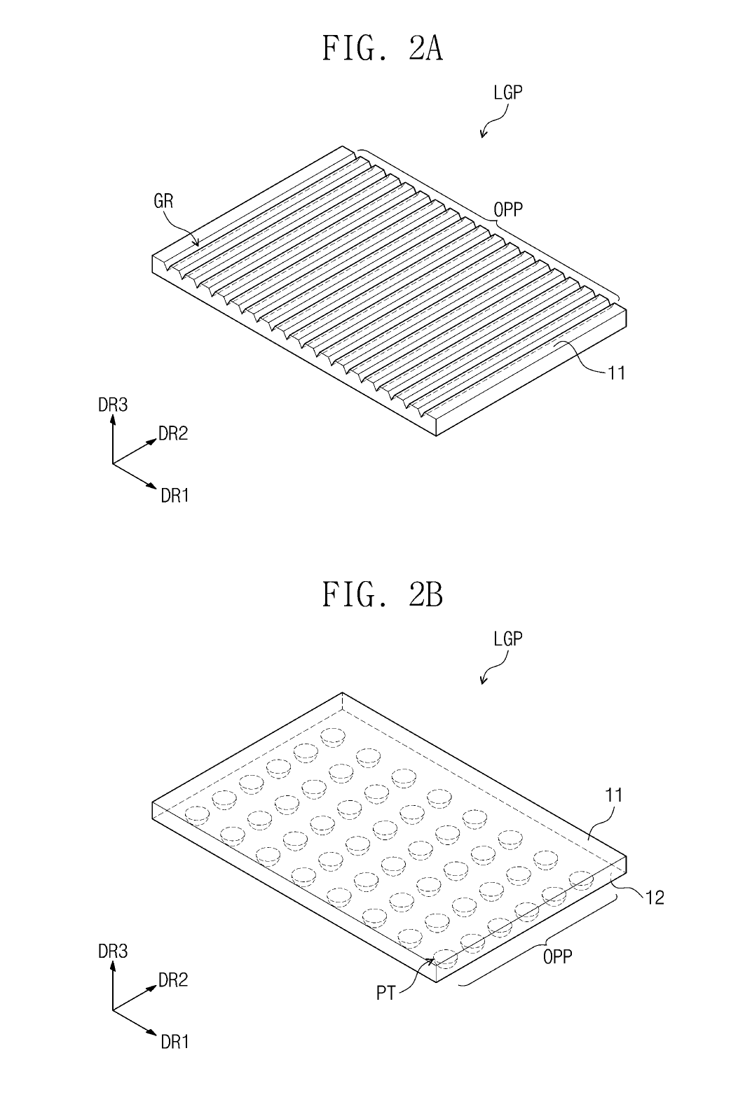

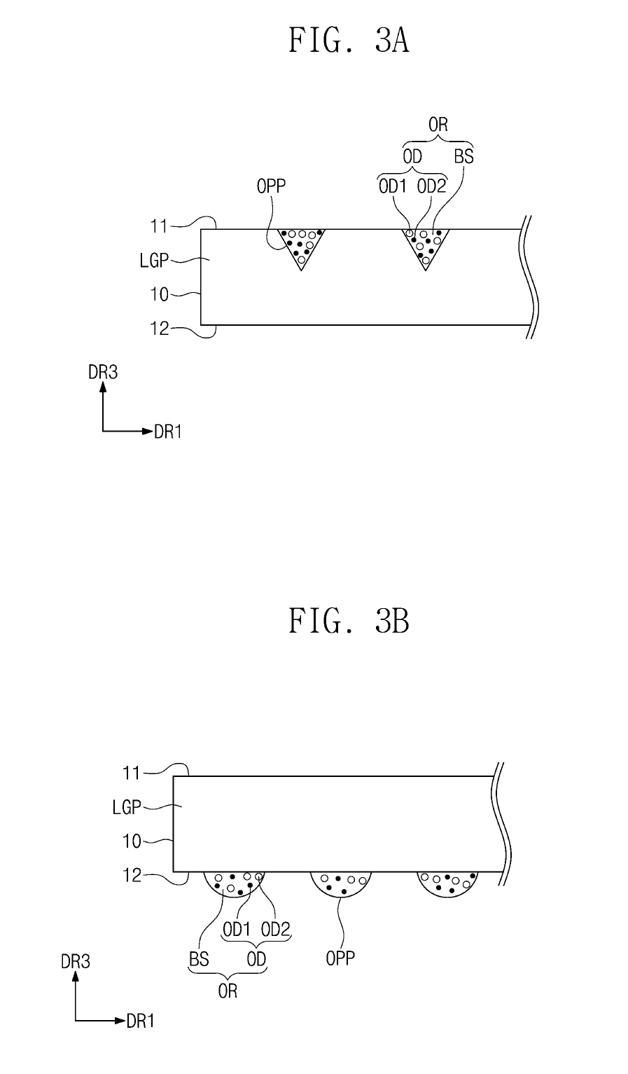

FIGS. 2A and 2B illustrate a light guide plate LGP in which a plurality of optical patterns OPP are formed according to an embodiment. FIG. 3A illustrates a light guide plate LGP in which an optical resin OR is included in the plurality of optical patterns OPP illustrated in FIG. 2A, and FIG. 3B illustrates an embodiment in which the plurality of optical patterns OPP illustrated in FIG. 3A are formed of an optical resin OR.

A light guide plate LGP according to an embodiment may include a plurality of optical patterns OPP on at least one face selected from among a light emitting face, a reflecting face, and a plurality of connecting faces. The plurality of optical patterns OPP may convert a first light received from a light source unit (LU, see FIG. 1) by changing the path of the first light or by changing the intensity of the first light through scattering. The plurality of optical patterns OPP may have various shapes according to which of the plurality of faces included in the light guide plate LGP the optical patterns OPP are formed on.

In an example, the plurality of optical patterns may include a plurality of recessed portions (e.g. depressions) formed in the light emitting face 11. As illustrated in FIG. 2A, the plurality of recessed portions GR may extend along a second direction DR2 and be lined up along a first direction DR1 on the light emitting face 11, and may be v-shaped and have a predetermined depth.

Contrary to FIG. 2A, the plurality of optical patterns OPP may instead be formed as variously shaped recessions, such as at least one selected from circular, polygonal, and semi-circular recessions. Alternatively, or in addition to, the optical patterns may also be formed protruding from the light emitting face 11.

Moreover, in an example, the plurality of optical patterns may, as illustrated in FIG. 2B, include a plurality of protruding portions PT protruding from the reflecting face 12. The plurality of protruding portions PT may be arranged spaced apart at predetermined intervals in each of the first direction DR1 and the second direction DR2. Although illustrated in FIG. 2B as a plurality of semi-circular protruding portions PT protruding from the reflecting face 12, the plurality of protruding portions PT may be formed such that the cross-sections thereof are variously shaped, for instance, in a polygonal or elliptic shape. The spacing and/or number of the plurality of protruding portions PT may be adjusted as desired.

The plurality of optical patterns OPP illustrated in FIGS. 2A and 2B may be formed through methods such as roll-stamping, injection molding, printing, or through a surface hardening method that utilizes a curable resin. Although the plurality of optical patterns OPP are illustrated in FIGS. 2A and 2B as being formed on only one of the light emitting face or the reflecting face among the plurality of faces forming the light guide plate LGP, differently shaped patterns may be respectively formed on at least two of the faces.

Referring to FIGS. 3A and 3B, a plurality of optical patterns OPP according to an embodiment may include an optical resin OR formed of an organic phosphor OD which converts the wavelength of incident light (a first light) received from the light source unit (LU, see FIG. 1) and a base material BS which accommodates the organic phosphors OD.

The organic phosphors OD may be organic materials that can emit light by being excited by light. The organic phosphors OD according to an embodiment may be fluorescent materials that absorb the first light and then emit the first light after changing the wavelength thereof. For example, the organic phosphors according to an embodiment may include at least one selected from poly(9,9-dioctyl)fluorine, poly(9,9-di(ethylhexyl)fluorine), poly(9,9-dioctylfluorene-co-benzothiadiazole), poly(9,9-dioctylfluorene-co-dithiophene), and at least one compound selected from the Compound Group 1 below.

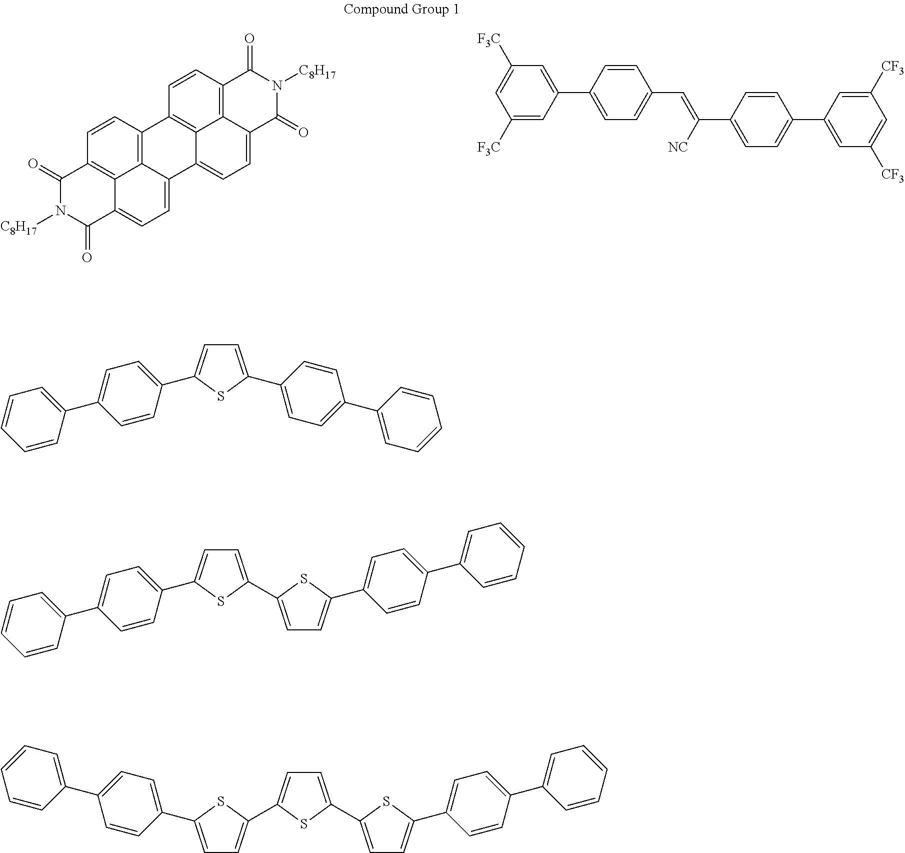

The organic phosphors OD according to an embodiment may be dispersed in the base material. The base material BS according to an embodiment of the may be a transparent polymer material, for example, at least one selected from polycarbonate, polyvinyl alcohol, polyimide, polyvinyl chloride, and the like.

More specifically, the organic phosphors OD may include a first organic phosphor OD1, which absorbs the first light and emits a second light, and a second organic phosphor OD2, which absorbs the first light and emits a third light. The second light may be a green light having a peak value in the wavelength range of, for example, about 500 to about 600 nm, and the third light may be a red light having a peak value in the wavelength range of, for example, about 600 to about 700 nm.

As illustrated in FIG. 3A, when the plurality of optical patterns OPP are formed to include a plurality of recessed portions on a light emitting face 11, the optical resin OR may be disposed so as to fill each of recessed portion of the plurality of recessed portions. In an example, the optical resin OR may be filled into each of the plurality of recessed portions to form, in combination with flat portions of the light emitting face 11, a surface structure that is parallel to the display panel (DP, see FIG. 1).

In another example, referring to FIG. 3B, when the plurality of optical patterns OPP are formed to include a plurality of protruding portions on the reflecting face 12, each of the plurality of protruding portions may be formed of only the optical resin OR. In a more specific example, the plurality of optical patterns OPP may be formed using an ink jet method to coat the optical resin on the reflecting face 12.

The first light incident on a light guide plate LGP according to an embodiment may be emitted after being converted into the second light or the third light while passing through the plurality of optical patterns OPP including the optical resin OR. More specifically, when the first light passes through the first organic phosphors OD1 contained in the optical resin OR, the first light may be converted into and emitted as the second light, and when the first light passes through the second organic phosphors OD2 contained in the optical resin OR, the first light may be converted into and emitted as the third light. Conversely, when the first light passes through the base material BS of the optical resin OR or a region of the light guide plate LGP in which the plurality of optical patterns OPP are not formed, the first light may be emitted as a fourth light having the same wavelength as the first light.

That is, by passing through the light guide plate LGP according to an embodiment, the first light provided from the light source unit may be emitted toward the display panel DP as a mixed light of the second light, the third light, and the fourth light. Here, the mixed light may be, for example, a white light.

Likewise, in a display device 100 according to an embodiment, the light guide plate LGP in which a plurality of optical patterns OPP are formed, may be used to enhance the brightness and viewing angle of light received from the light source unit LU and emit the light to a display panel DP. Moreover, since each of the plurality of optical patterns OPP includes the optical resin OR, the light guide plate LGP according to an embodiment, may emit to the display panel DP, the second light and third light converted from the first light received from the light source unit LU, and the fourth light. Consequently, an image having high color reproduction may be displayed, and the display device having enhanced optical efficiency may be realized.

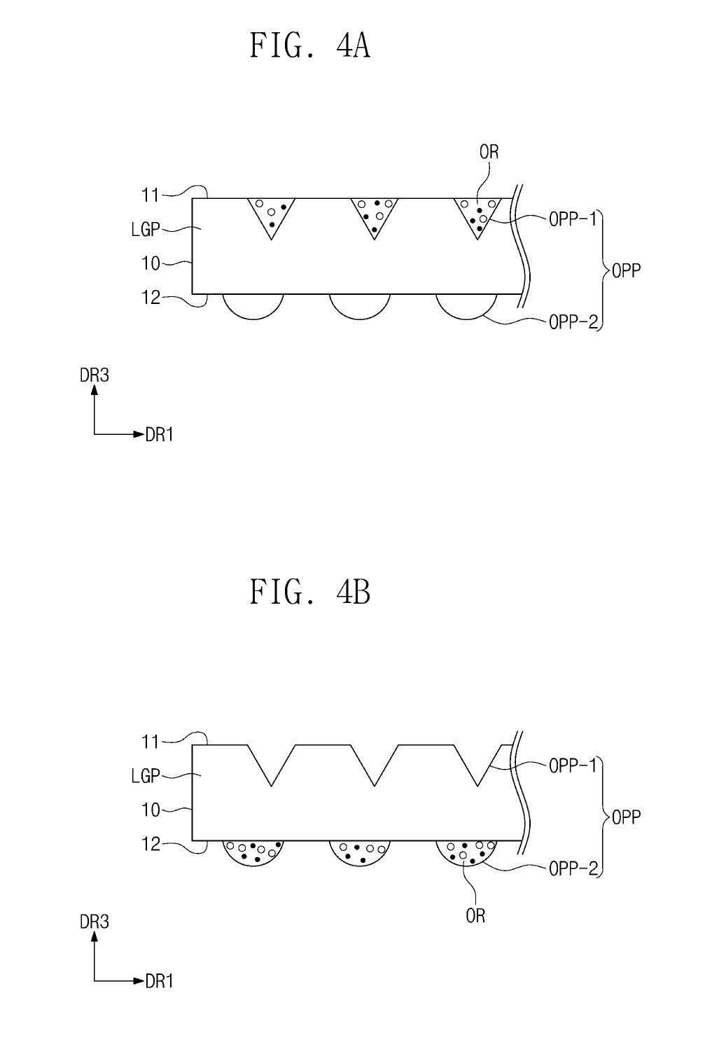

FIGS. 4A and 4B are cross-sectional views of a light guide plate LGP according to another embodiment.

A plurality of optical patterns OPP according to an embodiment of the may be formed on at least two faces of the light guide plate LGP. When the plurality of optical patterns OPP are formed on at least two faces of the light guide plate LGP, the plurality of optical patterns OPP respectively formed on different faces may have different shapes from each other. For example, when a first optical pattern OPP-1 is formed on a light emitting face 11 and a second optical pattern OPP-2 is formed on a reflecting face 12, the first optical pattern OPP-1 and the second optical pattern OPP-2 may have different shapes from each other.

Moreover, an optical resin OR according to an embodiment may be included in one of the first optical pattern OPP-1 or the second optical pattern OPP-2.

In a more specific example, referring to FIGS. 4A and 4B, a plurality of first optical patterns OPP-1 may be formed on the light emitting face 11 and a plurality of second optical patterns OPP-2 may be formed on the reflecting face 12. As illustrated in FIGS. 4A and 4B, the plurality of first optical patterns OPP-1 may be v-shaped (i.e., triangular in shape) and be recessed into the light emitting face 11, and the plurality of second optical patterns OPP-2 may be semi-circular and protrude from the reflecting face 12.

In an example, as in FIG. 4A, an optical resin OR according to an embodiment, may be filled into the plurality of recessed first optical patterns OPP-1. In this case, incident light received from a light source unit may be directed toward a display panel DP by the plurality of first optical patterns OPP-1 and the plurality of second optical patterns OPP-2, and the wavelength of the light may be converted as the light passes through the optical resin OR contained in the plurality of first optical patterns OPP-1.

Moreover, as in FIG. 4B, in an embodiment the plurality of second optical patterns OPP-2 may be formed as protruding semi-circular shapes made of the optical resin OR. In this case, of the incident light received from the light source unit, the wavelength of a portion that has traveled to the reflecting face 12 may be converted by the plurality of second optical patterns OPP-2 as the light is reflected toward the display panel DP.

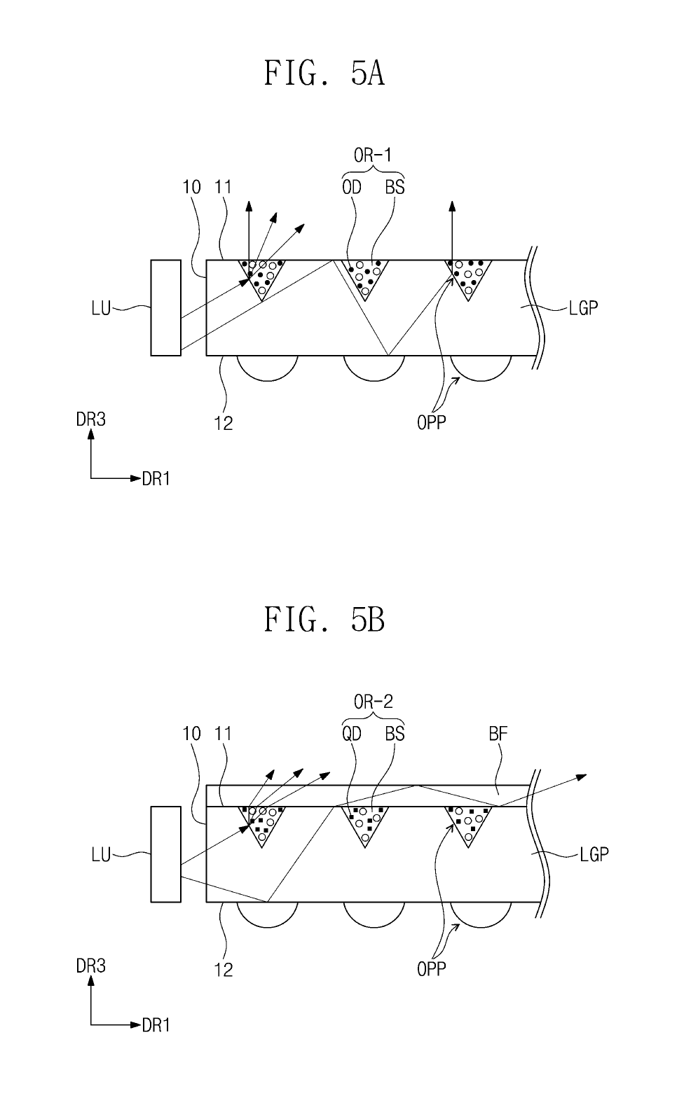

FIG. 5A is a cross-sectional view illustrating the path of light in a light guide plate LGP according to an embodiment, and FIG. 5B is a comparative cross-sectional view illustrating the path of light when a barrier film BF is disposed on the light guide plate LGP.

Referring to FIGS. 5A and 5B, a plurality of optical patterns OPP are formed on the light guide plate LGP according to an embodiment of the, and each of the plurality of optical patterns OPP may include a predetermined resin. In a more specific example, each of the plurality of optical patterns OPP in FIG. 5A may include an optical resin OR-1 formed of organic phosphors OD and a base material BS including the organic phosphors OD, and each of the plurality of optical patterns OPP in FIG. 5B may include an optical resin OR-2 formed of quantum dots QD and a base material BS including the quantum dots QD.

The organic phosphors OD contained in the optical resin OR-1 in FIG. 5A may be polymer materials that are comparatively resistant to moisture and oxygen. That is, the properties of the organic phosphors OD do not change even in the absence of a separate barrier material or barrier film for preventing the infiltration of moisture and oxygen. As illustrated in FIG. 5A, a first light incident through a light incident face 10 may be emitted after being converted into a second light or a third light while passing through the optical resin OR-1. The plurality of optical patterns OPP formed in the light guide plate LGP may cause the first light, the second light, or the third light to be emitted toward the display panel DP.

Conversely, the quantum dots QD contained in the optical resin OR-2 in FIG. 5B are materials that are susceptible to moisture and oxygen, and a barrier film BF for preventing the infiltration of moisture and oxygen may be disposed on a light emitting face 11, as in FIG. 5B. Referring to FIG. 5B, the first light incident through the light incident face 10 may be converted into a second light or a third light while passing through the optical resin OR-2. The plurality of optical patterns may cause the first light, the second light, or the third light to travel toward the display panel DP. However, after being emitted from the light guide plate LGP, the first light, second light, or third light traveling toward the display panel DP may be refracted while passing through the barrier film BF, as illustrated in FIG. 5B. That is, the light which have been emitted toward the display panel DP are refracted by the barrier film BF, and a portion of the emitted lights may not reach the display panel DP, but may instead leak to the outside.

Table 1 below is a table comparing the color reproduction and optical efficiency of a first display device using a light guide plate LGP that includes the organic phosphors OD and a second display device using a light guide plate that includes quantum dots QD.

TABLE 1

| | First display | | Second display | |
|---|---|---|---|---|
| | device (OD) | | device (QD) | |
| C.I.E | Cx | Cy | Cx | Cy |
| R | 0.6632 | 0.3209 | 0.6660 | 0.3199 |
| G | 0.2299 | 0.7179 | 0.2046 | 0.6986 |
| B | 0.1520 | 0.0326 | 0.1471 | 0.0448 |
| W | 0.3036 | 0.3136 | 0.3025 | 0.3148 |
| NTSC | 103.6% | 125.1% | 102.2% | 119.8% |

| | | |
|---|---|---|
| Brightness [nit] | 573 nit [100%] | 382 nit [66.7%] |

Referring to Table 1 above, it can be confirmed that the second display device including the quantum dots QD has a lower optical efficiency than the first display device including the organic phosphors OD.

As such, since the display device according to an embodiment does not include the placement of a barrier material or barrier film that allows for the leakage of light, optical efficiency may be improved. Moreover, since the thickness of the display device according to an embodiment may be reduced by excluding the barrier film, there is a thinning effect.

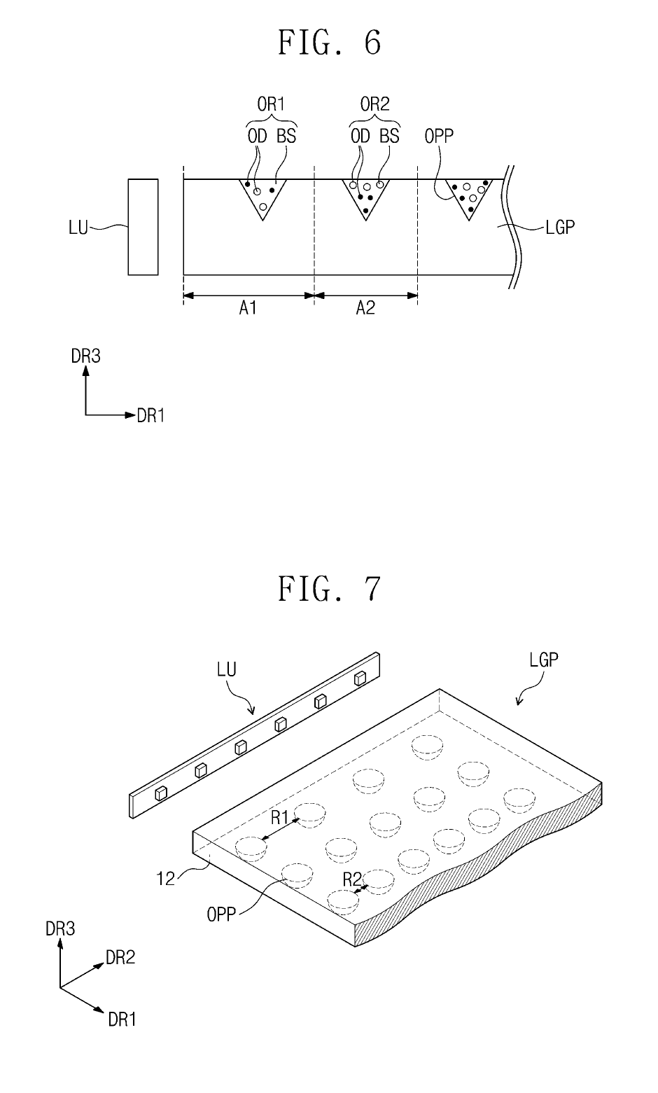

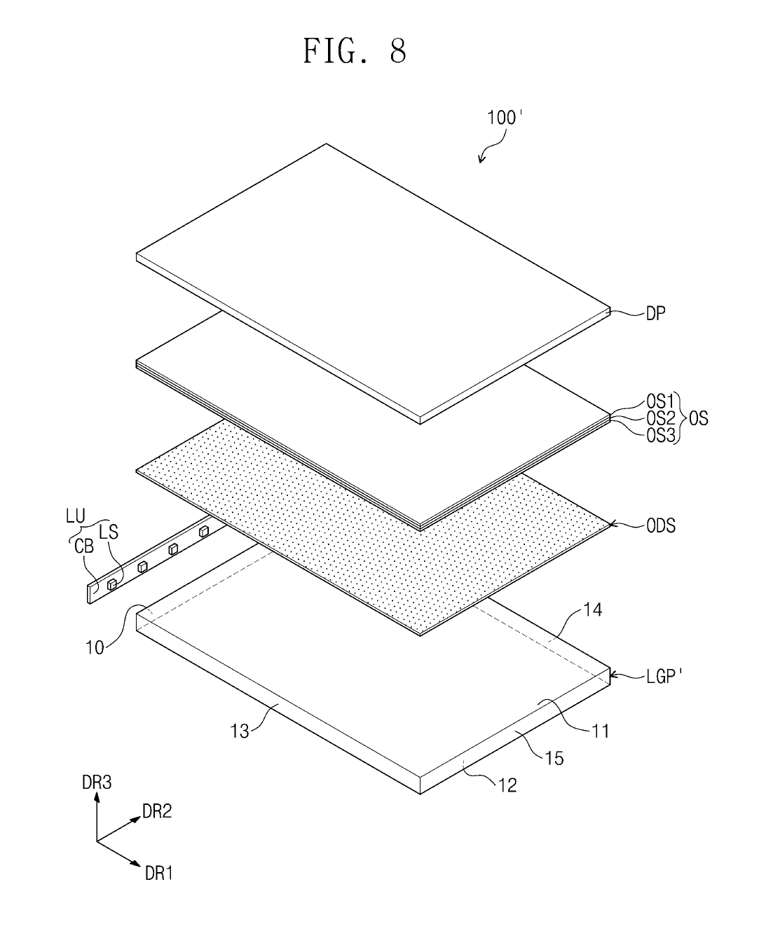

FIG. 6 is a cross-sectional view of a light guide plate LGP showing the change in the concentration of an optical resin OR according to the distance from a light source unit LU. FIG. 7 illustrates a portion of the light guide plate LGP which shows a change in the distance between optical patterns OPP according to the distance of the optical pattern OPP from the light source unit LU.

The light source unit LU according to an embodiment may be disposed to face a face (light incident face) of the light guide plate LGP. Here, the amount of light passing through the light guide plate LGP may decrease with the distance from the light source unit LU. In the display device according to an embodiment, in order to compensate for the decrease in the amount of light due to the distance from the light source unit, the concentration of the optical resin OR may be adjusted or the plurality of optical patterns OPP may be formed differently according to the position thereof on the light guide plate LGP. Here, the concentration of the optical resin OR may be defined by the number (i.e., the amount) of organic phosphors contained in a base material BS. That is, the greater the number of the organic phosphors OD in the base material BS, the higher the concentration in the optical resin.

In an example, referring to FIG. 6, the optical resin OR may be included in each of the plurality of optical patterns OPP according to an embodiment. More specifically, the light guide plate LGP according to an embodiment may include a first area A1 positioned relatively close to the light source unit LU and a second area A2 positioned further away from the light source unit LU than the first area A1. The concentration of a first optical resin OR1 contained in the optical patterns OPP formed in the first area A1 may differ from the concentration of a second optical resin OR2 contained in the optical patterns OPP formed in the second area A2. That is, the amount of organic phosphor OD contained in the first optical resin OR1 may be smaller than the amount of organic phosphor OD contained in the second optical resin OR2. Thus, in the display device according to an embodiment, the concentration of the optical resin OR varies according to the position of the optical pattern in the light guide plate LGP, and may be adjusted to compensate for the disadvantageous chromatic aberration resulting from the difference in refractive index for each wavelength of light due to the increased distance from the light source unit LU.

In another example, in the plurality of optical patterns OPP according to an embodiment, at least one selected from the spacing between the optical patterns OPP, the size of each of the optical patterns OPP, and the number of the optical patterns OPP, may be varied according to the distance from the light source unit LU. In a more specific example, referring to FIG. 7, the plurality of optical patterns OPP which are lined up along a first direction DR1 and extend along a second direction DR2, may be formed on a reflecting face 12. The spacing R1 between the optical patterns OPP which are positioned close to the light source unit LU in the first direction DR1, may be wider than the spacing R2 between the optical patterns OPP which are positioned at a distance further away from the light source unit LU in the first direction DR1. That is, the density of the optical patterns OPP may increase with the distance from the light source unit LU. Therefore, uniformity in the light emitted by the light guide plate LGP may be achieved over the entirety of the surface of the light guide plate LGP by keeping the amount of light emitted from an area of the light guide plate LGP positioned far from the light source unit LU similar to the amount of light emitted from an area of the light guide plate LGP positioned close to the light source unit LU.

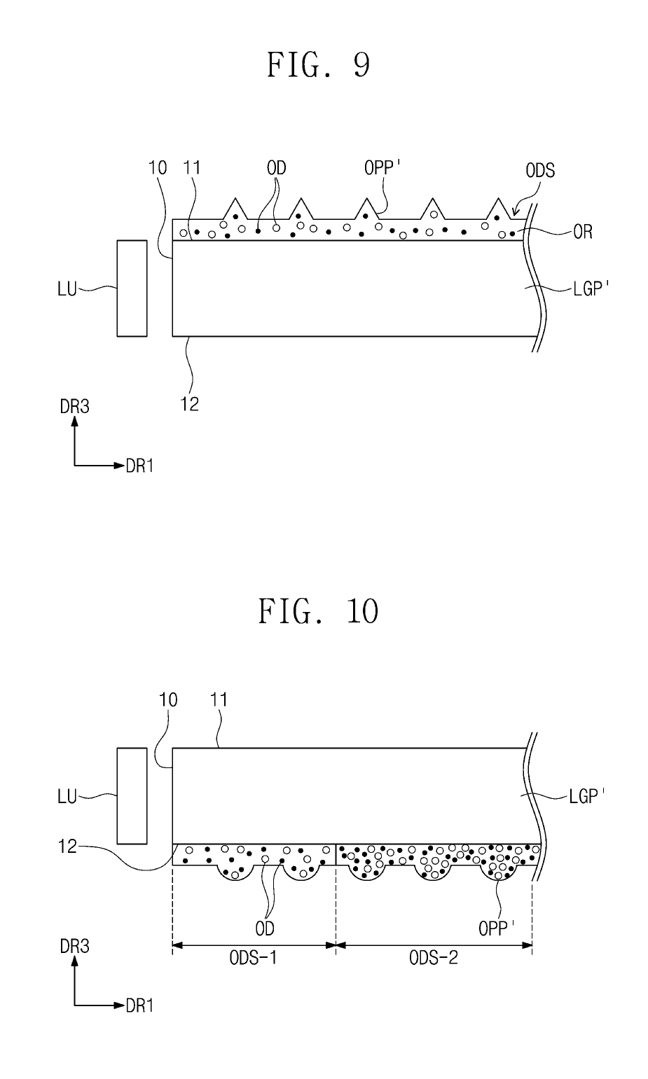

FIG. 8 is an exploded perspective view schematically illustrating a display device 100′ according to another embodiment, and FIG. 9 is a cross-sectional view illustrating a portion of a light guide plate LGP′ according to another embodiment. Hereinafter, repeat descriptions of elements already described above are excluded.

Referring to FIG. 8, a display device 100′ according to an embodiment of the may include an optical member ODS disposed on a face of a light guide plate LGP′. For example, as illustrated in FIG. 8, the optical member ODS may be disposed on a light emitting face 11 of the light guide plate LGP′. However, the optical member ODS is not limited thereto and may also be disposed on a light incident face 10 or a reflecting face 12, and may also be disposed on each of the light emitting face 11 and the reflecting face 12.

A plurality of optical patterns OPP′ for guiding a first light received from the light source unit LU toward a display panel DP, may be formed on the optical member ODS. In an example, as illustrated in FIG. 9, the plurality of optical patterns OPP′ may be formed in the shape of a prism and may control the path and intensity of the first light. Although the prism-shaped plurality of optical patterns OPP′ are shown in FIG. 9, the shape of the plurality of optical patterns is not limited thereto and may be varied.

Moreover, the optical member ODS may include organic phosphors OD for converting the wavelength of the first light received from the light source unit LU. As described with reference to FIGS. 3A and 3B, the organic phosphor includes a first organic phosphor OD1, which absorbs the first light and emits a second light, and a second organic phosphor OD2, which absorbs the first light and emits a third light. The optical member ODS may be, for example, a sheet that is formed as a resin composition including the organic phosphors OD is hardened. The organic phosphors OD according to an embodiment are polymer materials that are not susceptible to moisture and oxygen, and thus a barrier film that prevents the infiltration of moisture and oxygen may be omitted from the optical member ODS. That is, as illustrated in FIG. 8, since the top face of the optical member ODS disposed on the light emitting face 11 directly contacts an optical sheet OS when the display device 100′ is formed, there is an effect of reducing the overall thickness of the display device 100′. Moreover, the optical efficiency may be improved since, due to the refraction of light by the carrier film, leaked light is not generated.

FIG. 10 is a cross-sectional view illustrating a portion of a light guide plate LGP′ according to another embodiment of the.

Referring to FIG. 10, an optical member ODS according to an embodiment may be disposed so as to contact the reflecting face 12 of the light guide plate LGP′. The plurality of optical patterns OPP′ formed in the optical member ODS disposed on the reflecting face 12 of the light guide plate LGP′ may have a different shape than a plurality of optical patterns formed in the optical member ODS disposed on the light emitting face 11 of the light guide plate LGP′ as in FIG. 9.

In the optical member ODS according to an embodiment, the concentration of the organic phosphor OD may be made different for each area of the light guide plate LGP′ in order to compensate for the amount of light decreasing with the distance from the light source unit LU. More specifically, as illustrated in FIG. 10, the optical member ODS may include a first optical area ODS-1 positioned close to the light source unit LU in a first direction DR1, and a second optical area ODS-2 positioned further away from the light source unit LU in the first direction DR1 than the first optical area ODS-1.

According to an embodiment, the amount of the organic phosphor OD contained in the second optical area ODS-2 may be greater than the amount of the organic phosphor OD contained in the first optical area ODS-1.

Although not shown in the drawings, the optical member ODS may include the optical patterns OPP′ in which at least one selected from the number, interval, size, etc. thereof change with increased distance from the light source unit LU.

Therefore, a display device according to an embodiment of the may maintain uniformity between light emitted through an area of a light guide plate positioned far away from a light source unit and light emitted through an area of the light guide plate positioned close to the light source unit, and thereby overcome the limitation of chromatic aberration.

According to an embodiment, since light provided by a light source unit is converted by an optical pattern formed in a light guide plate, light having an improved viewing angle and improved brightness may be provided to a display panel. Moreover, since the light is provided to the display panel after the wavelength of a portion of the light is converted by an optical resin contained in the optical patterns, an image having high color reproduction may be displayed.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

Therefore, the technical scope of the present invention is not limited by the detailed description, and is only defined by the scope of the claims.

What is claimed is:

1. A display device comprising:
a light source unit which provides light;
a light guide plate which comprises a plurality of faces,
a plurality of optical patterns configured to convert incident light received from the light source unit, and disposed on at least one face of the plurality of faces; and
a display panel which is disposed on the light guide plate and configured to display an image by receiving light emitted from the light guide plate,
wherein each optical pattern of the plurality of optical patterns comprises an optical resin comprising an organic phosphor which converts a wavelength of the incident light, and a base material.

2. The display device of claim 1, wherein:
the plurality of faces comprise a light incident face, which faces the light source unit and a light emitting face, which is perpendicular to the light incident face and parallel to the display panel; and
the plurality of optical patterns further comprise a plurality of recessed portions defined in the light emitting face.

3. The display device of claim 2, wherein:
the plurality of recessed portions are v-shaped and have a predetermined depth; and
the optical resin is disposed so as fill each recessed portion of the plurality of recessed portions.

4. The display device of claim 1, wherein:
the plurality of faces comprises a light emitting face, which is configured to emit the converted incident light and a reflecting face, which is parallel to the light emitting face; and
the plurality of optical patterns further comprises a plurality of protruding portions which protrude from the reflecting face.

5. The display device of claim 4, wherein the plurality of protruding portions comprise the optical resin, and are disposed such that the cross-sections thereof have a shape selected from at least one of a circular shape, an elliptical shape, and a polygonal shape.

6. The display device of claim 1, wherein:
the plurality of faces comprise a light incident face, which faces the light source unit; and
with respect to the plurality of optical patterns, at least one selected from a spacing between the optical patterns, a size of each of the optical patterns, and a number of the optical patterns is changed according to a distance from the light source unit.

7. The display device of claim 6, wherein the spacing between the optical patterns decreases as a distance from the light incident face increases.

8. The display device of claim 1, wherein:
the light guide plate comprises a first area positioned a first distance from the light source unit; and a second area positioned a second distance from the light source unit, wherein the second distance is greater than the first distance and
wherein a first optical resin in the optical patterns disposed in the first area comprises an amount of the organic phosphor which is less than an amount of the organic phosphor in a second optical resin included in the optical patterns disposed in the second area.

9. The display device of claim 1, further comprising an optical sheet between the light guide plate and the display panel, wherein:
the plurality of faces comprises a light emitting face, which faces the display panel and is configured to emit the converted incident light; and
the plurality of optical patterns are disposed on the light emitting face.

10. The display device of claim 9, wherein the light emitting face and the optical sheet are in direct contact with each other.

11. The display device of claim 1, wherein:
the light source unit provides a first light to the light guide plate, and
the organic phosphor comprises a first organic phosphor which is configured to absorb the first light and emit a second light and a second organic phosphor which is configured to absorb the first light and emit a third light,
wherein the first light has a peak wavelength in the wavelength range of about 400 to about 500 nanometers, the second light has a peak wavelength in the wavelength range of about 500 to about 600 nanometers, and the third light has a peak wavelength in the wavelength range of about 600 to about 700 nanometers.

12. The display device of claim 1, wherein the organic phosphor comprises at least one compound selected from Compound Group 1,

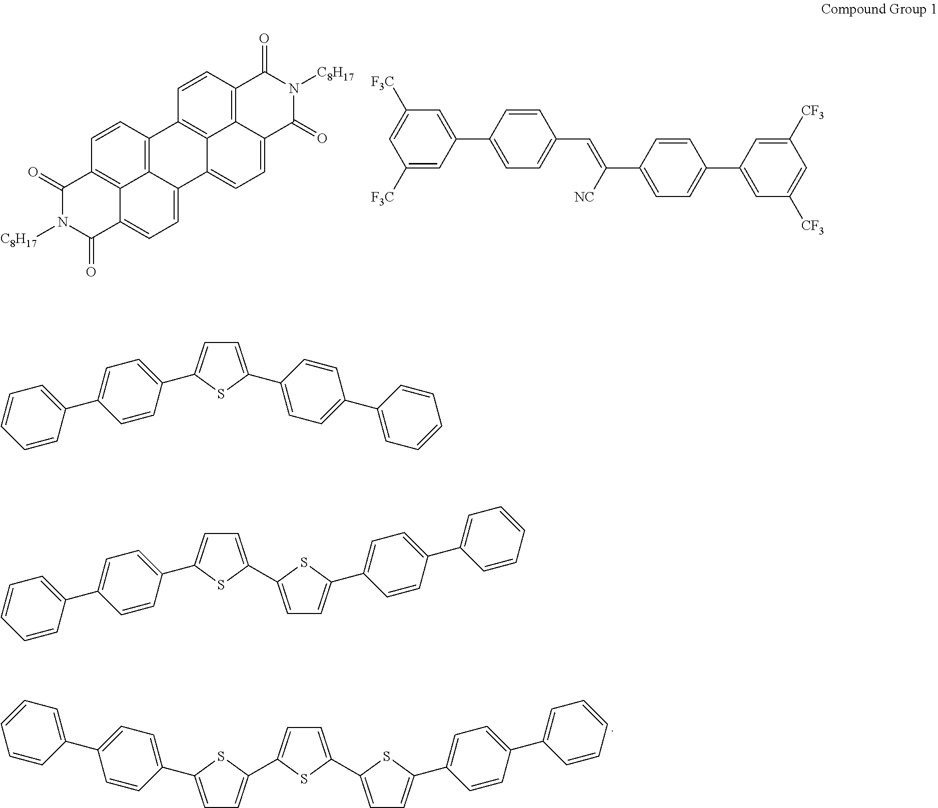

13. The display device of claim 1, wherein the organic phosphor comprises at least one selected from poly(9,9-dioctyl)fluorine, poly(9,9-di(ethylhexyl)fluorine), poly(9,9-dioctylfluorene-co-benzothiadiazole), and poly(9,9-dioctylfluorene-co-dithiophene).

14. A display device comprising,
an optical unit; and
a display panel disposed on the optical unit and configured to display an image,
wherein the optical unit comprises:
a light source unit which provides light;
a light guide plate which is configured to direct light received from the light source unit toward the display panel; and
an optical member disposed on a face of the light guide plate and comprising a plurality of optical patterns configured to convert the light received from the light source unit, wherein the optical member comprises an organic phosphor which converts a wavelength of the light received from the light source unit.

15. The display device of claim 14, wherein the optical member comprises, on the face of the light guide plate:
a first optical area positioned a first distance from the light source unit; and
a second optical area a second distance from the light source unit, wherein the second distance is greater than the first distance, and the second optical area comprises the organic phosphor in an amount which is greater than the amount of the organic phosphor in the first optical area.

16. The display device of claim 14, wherein:
the optical unit further comprises an optical sheet between the light guide plate and the display panel, and
a face of the light guide plate is a light emitting face which is configured to emit the converted light received from the light source.

17. The display device of claim 16, wherein the optical sheet is in direct contact with the optical member.

18. A display device comprising:
a light source unit which provides light;
a light guide plate comprising a light incident face which faces the light source unit, a light emitting face which is perpendicular to the light incident face and configured to emit light received from the light source unit, and a reflecting face which is perpendicular to the light incident face and parallel to the light emitting face; and
a display panel which is disposed on the light guide plate and configured to display an image by receiving light emitted from the light emitting face,
wherein a plurality of first optical patterns are provided on the light emitting face and a plurality of second optical patterns are provided on the reflecting face, and wherein at least one of the plurality of first optical patterns or the plurality of second optical patterns comprises an optical resin comprising an organic phosphor which is configured to convert a wavelength of the light received from the light source unit, and a base material.
